(19) United States
(12) Patent Application Publication
(10) Pub. No.: US 2023/0228145 A1
(43) Pub. Date: Jul. 20, 2023

(54) Low Profile, Garage Door Attachment, Which Deters Loose Debris From Entering the Contained Space

(71) Applicant: Adrian Marie Van Balen, Pittsburgh, PA (US)

(72) Inventor: Adrian Marie Van Balen, Pittsburgh, PA (US)

(21) Appl. No.: 18/157,582

(22) Filed: Jan. 20, 2023

Related U.S. Application Data
(60) Provisional application No. 63/301,351, filed on Jan. 20, 2022.

(51) Int. Cl. E06B 9/01

(52) U.S. Cl. CPC E06B 9/01; E06B 2009/015

(57) ABSTRACT

A low profile garage door attachment which deters loose debris from entering the contained space without unduly restricting movement in and out of said space is disclosed. The disclosed garage door attachment system and apparatus deters loose debris from entering the contained space by providing, in one embodiment, an easily attachable, robust netting system to block unwanted debris while the door is open. The garage door attachment may be configured to be low or small enough not to unduly restrict movement in and out of said space. The disclosed garage door attachment can also be configured to be retractable to a small size for storage when not in use.

### CROSS REFERENCE TO RELATED APPLICATIONS

The present application claims priority to U.S. Provisional Patent Application No. 63/301,351, filed on Jan. 20, 2022, the disclosure of which is hereby incorporated by reference in its entirety.

### BACKGROUND OF THE INVENTION

When a garage door or other similar door or barrier for an enclosed space or structure is left open, debris, such as blowing leaves and garbage, can blow into the garage or enclosed space. The debris then gets lodged behind items that may be stored in the garage, enclosed space, or structure making clean-up a difficult task.

One current system on the market for attempting to keep debris out of a garage fails to meet the needs of the industry for various reasons. That system is constructed of a flimsy material, covers the entire garage door opening, must be permanently installed, and is not stable enough at its base.

The disclosed system and apparatus for a garage door attachment advantageously fills these needs and addresses the aforementioned deficiencies by providing, in at least some preferred embodiments, an easily attachable, robust netting system to block unwanted debris while the door is open, which is low enough not to restrict movement in and out of said space, and retractable to a small size for storage when not in use.

### SUMMARY OF THE INVENTION

According to one aspect of the disclosure, a retractable and flexible barrier structure for partially blocking an opening in an enclosed structure is disclosed. According to another aspect of the disclosure, the retractable and flexible barrier structure may compromise a flexible panel supported by rigid members that may be removeably attached to structural or functional elements surrounding the opening of the enclosed structure. According to another aspect of the disclosure, the flexible panel may comprise netting or vinyl that may be printed on and the rigid members may comprise poles, tensor poles, or other rigid structures of various configurations that may be adjustably affixed to the flexible panel and to the sides of the opening of the enclosed structures such as a garage. Magnets may be used in some aspects of the disclosure to secure the barrier structure to the opening of the enclosed structure.

According to one aspect of the disclosure, a low profile garage door attachment which deters loose debris from entering the contained space of the garage without unduly restricting movement in and out of said space is disclosed. According to another aspect of the disclosure, the disclosed system and apparatus deters loose debris from entering the contained space by comprising, in one embodiment, an easily attachable, robust and retractable netting system to block unwanted debris while the door is open. According to another aspect of the disclosure, the system and apparatus may be configured to be low or small enough not to unduly restrict movement in and out of said space. According to another aspect of the disclosure, the disclosed system and apparatus can also be configured to be retractable to a small size for storage when not in use.

In accordance with an embodiment of the present invention, a barrier system configured to prevent debris from entering into an opening in an enclosed structure comprising: a flexible panel comprising a length sized to partially block a portion of the opening in the enclosed structure wherein said flexible panel comprises a first end, a second end, and a plurality of openings; a first rigid member attached to the first end of the flexible panel wherein said first rigid member comprises a handle and a plurality of connectors to connect the first rigid member to a structural element adjacent to the opening of the enclosed structure; a second rigid member attached to the second end of the flexible panel wherein said second rigid member comprises a handle and a plurality of connectors to connect the second rigid member to a structural element adjacent to the opening of the enclosed structure is disclosed.

In accordance with an embodiment of the present invention, the flexible panel may comprise netting surrounded by a border.

In accordance with an embodiment of the present invention, the enclosed structure may be a garage.

In accordance with an embodiment of the present invention, the first rigid member comprises a U-shaped tensor pole.

In accordance with an embodiment of the present invention, the second rigid member comprises a L-shaped tensor pole.

In accordance with an embodiment of the present invention, the connectors may comprise magnets.

In accordance with an embodiment of the present invention, the barrier system may comprise a plurality of connectable straps affixed to the flexible panel configured to adjust the length of the flexible member and put the flexible member in tension when the straps are connected to provide a taut fit between the barrier system and the opening.

In accordance with an embodiment of the present invention, the barrier system can be utilized wherein the enclosed structure is a garage, the flexible panel comprises netting surrounded by a border, the first rigid member comprises a U-shaped tensor pole, the second rigid member comprises a L-shaped tensor pole, the connectors comprise magnets, the structural element adjacent to the opening of the enclosed structure comprises a garage door rail, and the barrier system further comprises a plurality of connectable straps affixed to the flexible panel configured to adjust the length of the flexible panel and put the flexible panel in tension when the straps are connected to provide a taut fit between the barrier system and the opening.

In accordance with an embodiment of the present invention, a garage door attachment may comprise: a first tensor pole comprising a plurality of connectors configured to attach to a structure for a garage door; a second tensor pole comprising a handle and a polarity of connectors configured to attach to a structure for a garage door; a flexible panel sized to span the width of a garage door opening and configured to be rolled up for storage, wherein said panel comprises a first side, a second side, a first end, a second end, a plurality edges, and a border affixed to said plurality of edges, wherein said first end is affixed to said first tensor pole and said second end is affixed to said second tensor pole with a plurality of tightening straps; and a plurality of support poles connected to said second side of said flexible support panel.

In accordance with an embodiment of the present invention, the first tensor pole is L-shaped and said second tensor pole is U-shaped.

In accordance with an embodiment of the present invention, the plurality of tightening straps attach said flexible panel to said first and second tensor poles and are configured to pull said flexible panel taut to block a portion of a garage door opening.

In accordance with an embodiment of the present invention, the flexible panel may comprise netting.

In accordance with an embodiment of the present invention, the border may comprise a durable material constructed to withstand abrasion and a reflective surface.

In accordance with an embodiment of the present invention, the garage door attachment may further comprise a plurality of straps affixed to said first tensor pole and to said flexible panel configured to secure the flexible panel to said first tensor pole when said flexible panel is rolled up for storage.

In accordance with an embodiment of the present invention, the garage door attachment may further comprise a plurality of cords constructed of wire, rope, or comparable materials connecting the first and second tensor poles to each other through a sleeve constructed in said flexible panel.

In accordance with an embodiment of the present invention, the connectors may comprise magnets or wall mounts.

In accordance with an embodiment of the present invention, the garage door attachment may further comprise a wedge affixed to said border on said first side of said flexible panel configured to span the length of said garage door attachment and scrape debris away from a garage opening.

In accordance with an embodiment of the present invention, the flexible panel may be constructed of materials that may be printed upon.

In accordance with an embodiment of the present invention, a garage door attachment may comprise a first tensor pole comprising: an inverted U-shape with a handle and plurality of magnets configured to attach the first tensor pole to a first garage door rail; a second tensor pole comprising an inverted L-shape with a handle and a plurality of connectors configured to attach the second tensor pole to a second garage door rail; a netting sized to span the width of a garage door opening and configured to be rolled up for storage, wherein said netting comprises a first end and a second end, and said netting is surrounded by a border, wherein said first end of said netting is affixed to said first tensor pole and said second end of said netting is affixed to said second tensor pole with a plurality of tightening straps; and a plurality of rigid poles connected to said netting between said first end and said second end.

### BRIEF DESCRIPTION OF THE DRAWING(S)

FIG. 1 is a front side view of a garage door attachment showing the side facing the outside of the garage.

FIG. 2 is a back side view of a garage door attachment showing the side facing the inside of the garage.

FIG. 3 is a perspective view of a U-shaped tensor pole attached at one end of a garage door attachment.

FIG. 4 is a perspective view of a L-shaped tensor pole attached at one end of a garage door attachment.

FIG. 5 is a perspective view of one end of a garage door attachment with a L-shaped tensor pole installed on the track of the garage door.

FIG. 6 is a perspective view of one end of the back side of another embodiment of a garage door attachment with a U-shaped tensor pole.

FIG. 7 is a perspective view of one end of the front side of another embodiment of a garage door attachment with a U-shaped tensor pole.

FIG. 8 is a perspective view of one end of the front side of another embodiment of a garage door attachment with a U-shaped tensor pole.

FIG. 9 is a perspective view of the back side of another embodiment of a garage door attachment showing the side facing the inside of the garage.

FIG. 10 is a perspective view of the front side of another embodiment of a garage door attachment showing the side facing the outside of the garage.

### DESCRIPTION OF THE INVENTION

As stated above, when a garage or other similar door is left open, debris, such as blowing leaves and garbage, find their way into the garage or other enclosed area. The debris then gets lodged behind items stored in the garage or other enclosed space, making clean-up a difficult task. The system and apparatus disclosed herein solves this problem.

According to one aspect of the disclosure, the disclosed garage door attachment easily attaches to the rails of a garage door and spans the width of the opening to impede the advancement of debris across the threshold of the garage space. It has a low profile close to the floor of the garage or enclosed space to easily allow egress or ingress without removing the system. In some embodiments of the attachment, an adult person can easily step over the disclosed garage door attachment. When the garage door needs to be closed or a vehicle needs to enter or exit, the garage door attachment is effortlessly retracted or wound up so that it can be be stored to the side of the garage door opening.

The garage door attachment disclosed herein is an improvement on what currently exists. Systems currently on the market do not allow the garage space to be kept free of debris and easily accessed. Garage spaces are often used with the intent of easily being able to access the outdoor space located around the garage. With a high demand for people who work in garages being able to access both inside and out, the disclosed system and apparatus allows for the space to be easily accessible and allows the garage to be maintained at a desired level of cleanliness.

One system currently on the market does not work well for a few reasons. First, it is too flimsy of a material to withstand the constant wear and tear of the frequent ingress and egress of a working garage space. Secondly, it covers your entire garage door opening, making it difficult to bring objects in and out of said garage space. Thirdly, it must be permanently installed, without the option of easily removing it. Lastly, it is not stable enough at its base to withstand a brisk wind, which is often accompanied with the debris that clutters up a garage.

Some embodiments of the disclosed garage door attachment system and apparatus advantageously fill these needs and addresses the aforementioned deficiencies by providing an easily attachable, robust netting system to block unwanted debris while the door is open, which is low enough not to restrict movement in and out of said space, and retractable to a small size for storage when not in use.

In one embodiment, the garage door attachment comprises: right and left rigid members, such as tensor poles, with two connectors for garage tracks on each rigid member, with one of the tensor poles in the shape of an upside down “U”, which will be used to wind up the device for storage, and the other tensor pole will be in the shape of an upside down “L”, with a handle to drag debris away from the opening; tightening straps, which attach a flexible panel such as netting to the tensor poles, to pull the flexible panel or netting taut so that it completely blocks off the entrance; netting or other flexible printable material that spans the width of the opening for the garage door and that is also able to be printed on; a border that outlines the netting or flexible material which is made of a durable material to withstand abrasion; a reflective surface on the top of the aforementioned border to provided high visibility; support poles throughout the length of the back of the netting facing the inside of the garage and the border to provide vertical support while the flexible panel or netting is under tension; two straps on the flexible panel or netting that, once wound up or retracted for storage, will secure the flexible panel or netting to prohibit unraveling; wall mounts, where applicable, to attach tensor poles to the wall instead of tracks of garage door if a more permanent fixture is desired; and a wedge on the bottom of the border, facing out, that spans the length of the garage door attachment to scrape debris away from garage opening.

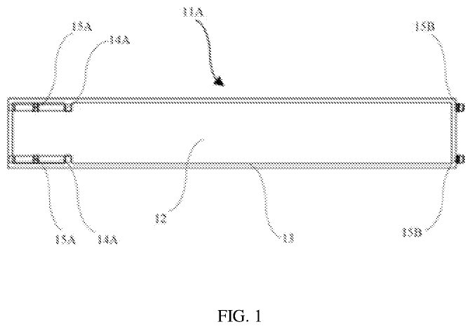

FIG. 1 shows the front side 11A of the garage door attachment that would be facing towards the outside of the garage door. The garage door attachment in this embodiment comprises a flexible panel comprising netting or a printable surface 12 and a border 13 attached along the outside edges of the flexible panel or netting 12. An L-shaped tensor pole 42 is attached to a first end of the flexible panel 12 or border 13 by buckles 15A and a U-shaped tensor pole 32 is attached to a second end of the flexible panel or netting 12 or border 13 by buckles 15B. Tightening straps 14A allow the garage door attachment to be pulled tight for a perfect fit to a garage door.

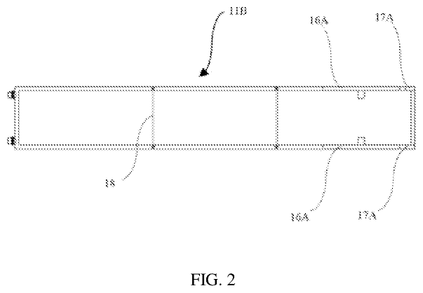

FIG. 2 shows the back side 11B of the garage door attachment that would be facing inward towards the garage. Straps 16A and 17A comprise hook and loop fasteners, such as Velcro®, that can be used to adjust the width of the garage door attachment for a custom fit. Support poles 18 can be used to keep the garage door attachment upright in the middle of the device.

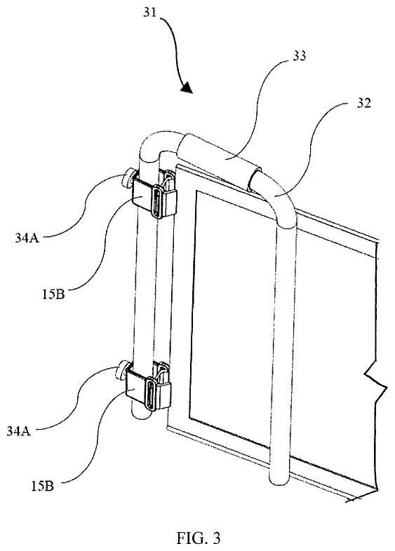

FIG. 3 shows the U-shaped tensor pole 32 comprising a handgrip 33 and magnets 34A which are used to attach a second end 31 of the garage door attachment to the garage door tracks. Buckles 15B can be used to attach the tensor pole 32 to the flexible panel or netting 12.

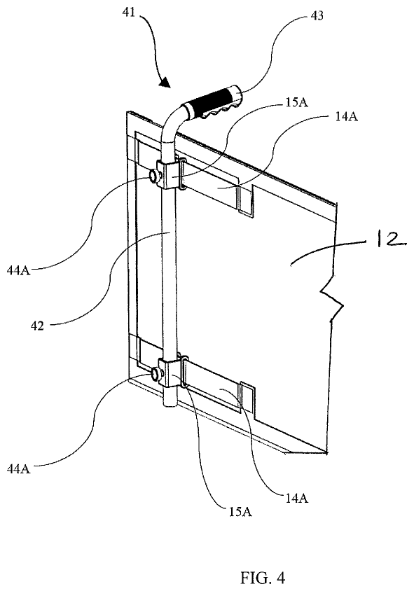

FIG. 4 shows the L-shaped tensor pole 42 comprising a hand grip 43 and magnets 44A to attach a first end 41 of the garage door attachment to the garage door track. Buckles 15A can be used to attach the tensor pole 42 to the flexible panel or netting 12, border 13 and/or tightening straps 14A.

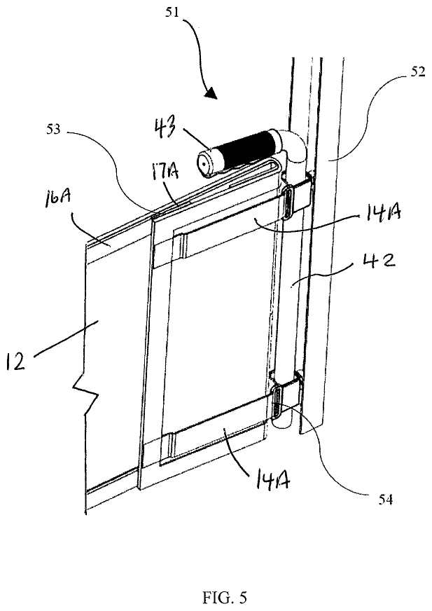

FIG. 5 shows the garage door attachment 51 installed on the garage door track 52 with the flexible panel or netting 12 folded over such that straps 16A and 17A comprising hook & loop fasteners can be releaseably affixed to each other at location 53 for a custom fit and the buckles 15A and tightening straps 14A form a loop 54 that allows the first end 41 of the flexible panel or netting 12 to pulled and tightened to ensure the flexible panel or netting 12 stays taut.

The garage door attachment 51 may, in some embodiments, as shown in FIGS. 2 and 3, be assembled by assembling the U- and L-shaped tensor poles 32, 42, respectively, with magnets 34A, 44A through designated openings in the buckles 15A, 15B and attaching the handles 33, 43 at the top of each pole 32, 42. The straps are attached at the top and bottom of the netting 12 to both of the above mentioned tensor poles 32, 42.

The vertical support poles 18 may be placed at a plurality of locations throughout the length of the netting 12 at designated place holders on the back side 11B of the attachment 51 and the flexible panel or netting 12 as shown in FIG. 2. The length needed to completely seal off the garage opening must then be determined and the straps 14A may be adjusted accordingly to ensure the flexible panel or netting 12 stays taut.

The garage door attachment 51, in some embodiments, comprises U- and L-shaped tensor poles 32, 42, respectively, attachments, such as magnets 34A, 44A, to adhere them to the garage door track 52, the flexible panel or netting 12, the tightening straps 14A, and the vertical support poles 18. Other optional elements could include a reflective strip for visibility, straps to keep the system wound up during storage, wall mounting brackets, or a lower, front facing “wedge” to scrape debris away from your garage opening.

Another component of the garage door attachment may comprise an attachment system not based off of magnets, but one based off of securing an expandable device to fill the inside of the garage door track to ensure a firm connection.

To seal off garage space from outside debris, in one embodiment of the system and apparatus, the L-shaped tensor pole 42 may be attached to the garage door track 52 as shown, for example, in FIG. 5. The flexible panel or netting 12 may be wound or unwound around the U-shaped tensor pole 32 and may span the width of the garage door. The U-shape tensor pole 32 may be attached to the opposite garage door track. The flexible panel or netting 12 then may be pulled taut with the attached straps 14A by the L-shaped tensor pole 42 to cover a portion of the opening of the garage door, preferably the portion of the opening adjacent the floor of the garage.

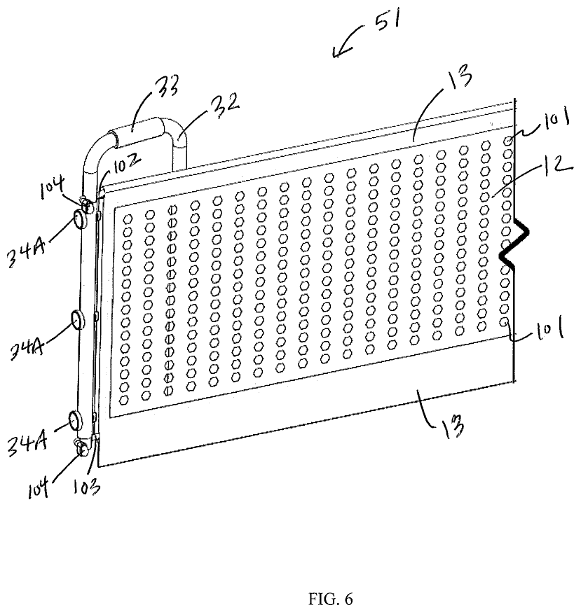

Other embodiments of the garage door attachment system and apparatus are shown in FIGS. 6-10. FIG. 6 shows one end of the back side 11B, or the garage facing side, of the attachment 51 comprising a flexible panel 12 with a border 13 comprising a plurality of perforations, openings, or holes 101 in the flexible panel or netting 12.

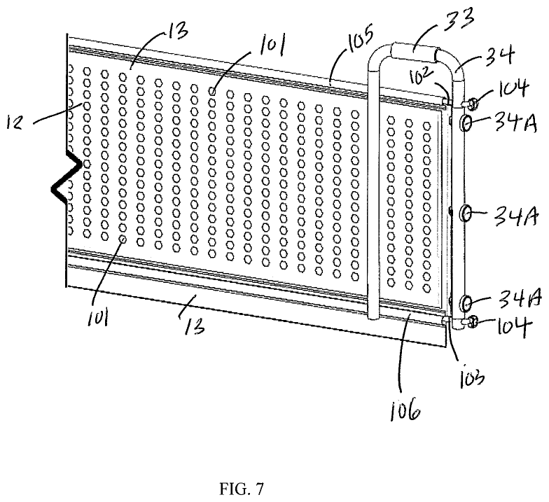

As best shown in FIG. 7, the U-shaped tensor pole 32 is connected to the end of the flexible panel 12 via a first flexible cord 102 with an end stop 104 and a second flexible cord 103 with an end stop 104. The first flexible cord 102 can be positioned within a first top sleeve 105 and the second flexible cord 103 can be positioned within a second bottom sleeve 106 incorporated into the flexible panel 12. The flexible cords 103, 103 may be constructed of wire, rope, or other suitable durable elongated materials and may extend through a hole or opening in the U-shaped tensor pole 32 and held in position by the end stops 104. The U-shaped tensor pole 32 further comprises three magnets 34A configured to be attached to a structure associated with the garage door, such as the garage door rail 52.

FIG. 7 shows one end of the front side 11A, or the outside facing side, of the attachment 51 comprising a flexible panel 12 with a border 13 comprising a plurality of perforations, openings, or holes 101 in the flexible panel or netting 12. One side of the U-shaped tensor pole 32 may be connected to the end of the flexible panel 12 and comprises three magnets 34A configured to be attached to a structure associated with the garage door such as the garage door rail 52, and the other side of the U-shaped tensor pole 32 extends down the front side of the flexible panel 12.

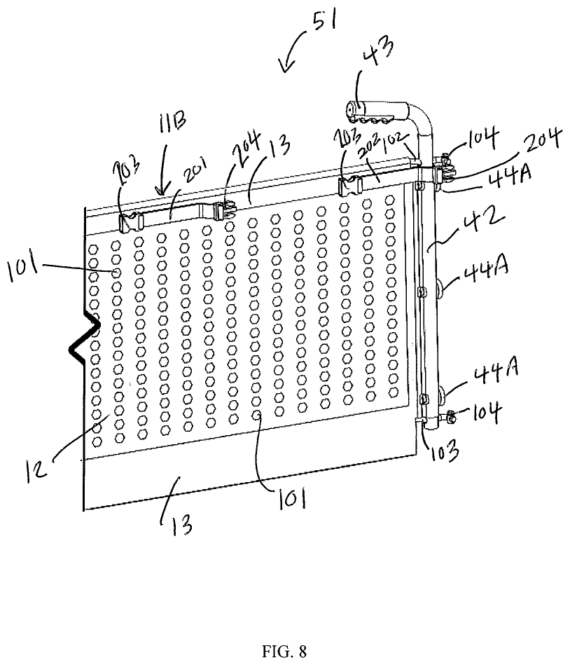

FIG. 8 shows one end of the back side 11B, or the inside facing side, of the attachment 51 comprising a flexible panel 12 with a border 13 comprising a plurality of perforations, openings, or holes 101 in the flexible panel or netting 12. Tightening straps 201, 202 with male 204 and female 203 couplings on their opposite ends can be affixed to the flexible panel 12 and/or border 13 and are configured such that the male and female couplings 203, 204 can be joined or snapped into each other so as to pull the flexible panel 12 tight or taut across the opening for the garage door. A L-shaped tensor pole 42 may be connected to the end of the flexible panel 12 or border 13 via a first flexible cord 102 with an end stop 104 and a second flexible cord 103 with an end stop 104 in the same manner that the U-shaped tensor pole 32 is connected to the flexible panel as best shown in FIG. 8. A L-shaped tensor pole 42 may comprise a plurality of magnets such as the three magnets shown in FIG. 8.

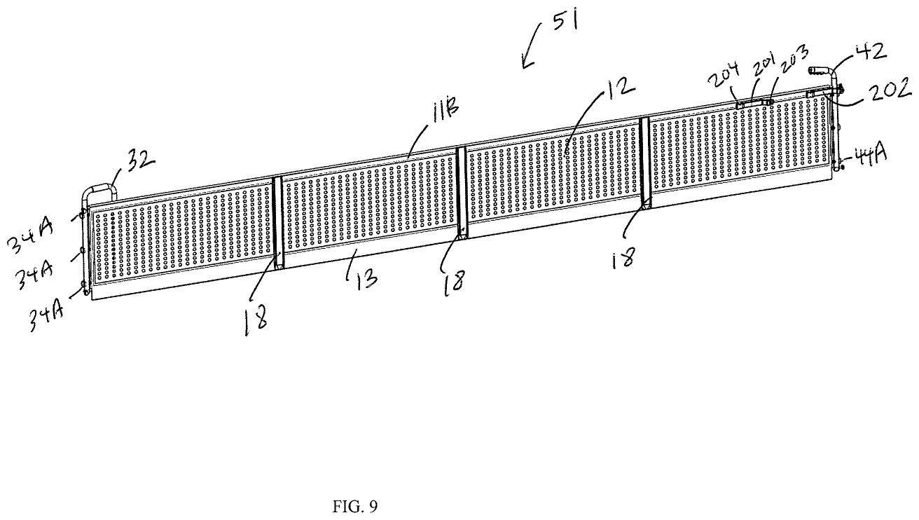

FIG. 9 shows another embodiment of the back side 11B of the garage door attachment 51 that would be facing inward towards the garage. Tightening straps 201, 202 comprising male 204 and female 203 couplings on their opposite ends can be affixed to the flexible panel 12 or its border 13 and used to adjust the width of the garage door attachment 51 across the garage door opening for a custom fit. A U-shaped tensor pole 32 with magnets 34A is connected to one end of the flexible panel 12 and a L-shaped tensor pole 42 with magnets 44A may be attached to the other end of the flexible panel 12 or border 13. A plurality of support poles 18 connect to the flexible panel 12 can be used to keep the garage door attachment 51 and flexible panel 12 taut and upright.

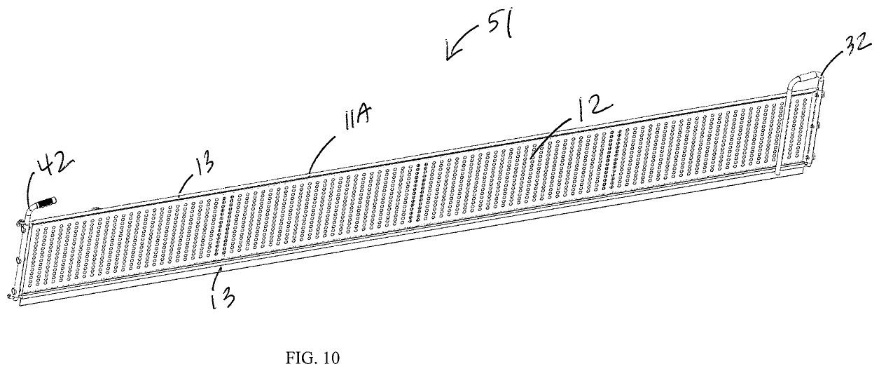

FIG. 10 shows another embodiment of the front side 11A of the garage door attachment 51 that would be facing towards the outside of the garage door. The garage door attachment in this embodiment comprises a flexible panel 12 comprising netting or a printable surface 12 and a border 13 attached along the outside edges of the flexible panel or netting 12. A L-shaped tensor pole 42 is attached to a first end of the flexible panel or netting 12 and a U-shaped tensor pole 32 is attached to a second end of the flexible panel or netting 12 as described herein above.

The front side 11A and back side 11B of the garage door panel can be flipped in the direction they face when they are installed in a garage such that either side can face the inside of garage or the outside of the garage.

While examples of the garage door attachment system and apparatus set forth in the present disclosure are shown in the accompanying figures and described hereinabove in detail, other examples will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A barrier system configured to prevent debris from entering into an opening in an enclosed structure comprising:
a flexible panel comprising a length sized to partially block a portion of the opening in the enclosed structure wherein said flexible panel comprises a first end and a second end and a plurality of openings;
a first rigid member attached to the first end of the flexible panel wherein said first rigid member comprises a handle and a plurality of connectors to connect the first rigid member to a structural element adjacent to the opening of the enclosed structure; and
a second rigid member attached to the second end of the flexible panel wherein said second rigid member comprises a handle and a plurality of connectors to connect the second rigid member to a structural element adjacent to the opening of the enclosed structure.

2. The barrier system of claim 1, wherein the flexible panel comprises netting surrounded by a border.

3. The barrier system of claim 1, wherein the enclosed structure is a garage.

4. The barrier system of claim 1, wherein the first rigid member comprises a U-shaped tensor pole.

5. The barrier system of claim 1, wherein the second rigid member comprises a L-shaped tensor pole.

6. The barrier system of claim 1, wherein the plurality of connectors comprise magnets.

7. The barrier system of claim 1, wherein the structural element adjacent to the opening of the enclosed structure comprises a garage door rail.

8. The barrier system of claim 1, further comprising a plurality of connectable straps affixed to the flexible panel configured to adjust the length of the flexible panel and put the flexible panel in tension when the straps are connected to provide a taut fit between the barrier system and the opening.

9. The barrier system of claim 1, wherein:
the enclosed structure is a garage;
the flexible panel comprises netting surrounded by a border;
the first rigid member comprises a U-shaped tensor pole;
the second rigid member comprises a L-shaped tensor pole;
the plurality of connectors comprise magnets;
the structural element adjacent to the opening of the enclosed structure comprises a garage door rail; and
the barrier system further comprises a plurality of connectable straps affixed to the flexible panel configured to adjust the length of the flexible panel and put the flexible panel in tension when the straps are connected to provide a taut fit between the barrier system and the opening.

10. A garage door attachment comprising:
a first tensor pole comprising a plurality of connectors configured to attach to a structure for a garage door;
a second tensor pole comprising a handle and a plurality of connectors configured to attach to a structure for a garage door;
a flexible panel sized to span a width of a garage door opening and configured to be rolled up for storage wherein said panel comprises a first side and a second side, a first end and a second end, and a plurality edges and a border affixed to said plurality of edges, wherein said first end is affixed to said first tensor pole and said second end is affixed to said second tensor pole with a plurality of tightening straps; and
a plurality of support poles connected to said second side of said flexible support panel.

11. The garage door attachment of claim 10 wherein said first tensor pole is L-shaped and said second tensor pole is U-shaped.

12. The garage door attachment of claim 10 wherein said plurality of tightening straps attach said flexible panel to said first and second tensor poles and are configured to pull said flexible panel taut to block a portion of a garage door opening.

13. The garage door attachment of claim 10 wherein said flexible panel comprises netting.

14. The garage door attachment of claim 10 wherein said border comprises a durable material constructed to withstand abrasion and a reflective surface.

15. The garage door attachment of claim 11 further comprising a plurality of straps affixed to said first tensor pole and to said flexible panel configured to secure the flexible panel to said first tensor pole when said flexible panel is rolled up for storage.

16. The garage door attachment of claim 11 further comprising a plurality of cords connecting the first and second tensor poles to each other through a sleeve constructed in said flexible panel.

17. The garage door attachment of claim 11 wherein said plurality of connectors comprise magnets.

18. The garage door attachment of claim 10 further comprising a wedge affixed to said border on said first side of said flexible panel configured to span the length of said garage door attachment and scrape debris away from a garage door opening.

19. The garage door attachment of claim 10 wherein said flexible panel is constructed of materials that may be printed upon.

20. A garage door attachment comprising:
a first tensor pole comprising an inverted U-shape with a handle and plurality of magnets configured to attach the first tensor pole to a first garage door rail;
a second tensor pole comprising an inverted L-shape with a handle and a plurality of connectors configured to attach the second tensor pole to a second garage door rail;
netting sized to span the width of a garage door opening and configured to be rolled up for storage wherein said netting comprises a first end and a second end, and said netting is surrounded a border, wherein said first end of said netting is affixed to said first tensor pole and said second end of said netting is affixed to said second tensor pole with a plurality of tightening straps; and
a plurality of rigid poles connected to said netting between said first end and said second end.
